(19) United States
(12) Patent Application Publication
(10) Pub. No.: US 2011/0111142 A1
(43) Pub. Date: May 12, 2011

(54) LABEL AND METHOD OF MANUFACTURING THE SAME

(75) Inventors: Young Hee Kim, Gwacheon-si (KR); Han Jun Kang, Suwon-si (KR); Woo Sic Jung, Ansan-si (KR); Sung Ho Lee, Ansan-si (KR)

(73) Assignee: YOUL CHON CHEMICAL CO., LTD., Seoul (KR)

(21) Appl. No.: 12/992,849

(22) PCT Filed: May 15, 2009
(86) PCT No.: PCT/KR2009/002597

§ 371 Date: Nov. 15, 2010

(30) Foreign Application Priority Data
May 16, 2008 (KR) 10-2008-0045796

(51) Int. Cl. G09F 3/02; B32B 9/00; B32B 27/06; B05D 3/06

(52) U.S. Cl. 428/29; 428/41.8; 428/43; 428/205; 428/204; 427/554

(57) ABSTRACT

Disclosed are a label and a method of manufacturing the same, the label comprising: a first base film; a first ink layer formed on the exterior top part of the first base film, and comprising a metal or metal oxide that changes from its original color to another color by being oxidized by a laser; and a resin coating layer coated on the first ink layer to protect the first ink layer, wherein the laser passing through a part or the whole of the resin coating layer is transmitted to the first ink layer. According to the present invention, there is no oxidation residue; thus, the efficiency of marking is excellent and any possibility of change in quality due to aging can be eliminated. In addition, the color rendering is excellent, and the scratch resistance, chemical resistance and heat resistance are superior.

### TECHNICAL FIELD

This disclosure relates to a label and a method for preparing the same. More particularly, it relates to a label with preventing the possibility of decreased marking efficiency or quality change with time due to the presence of oxidation residues inside a base film of the label when subjected to laser marking and at the same time having improved scratch resistance, and a method for preparing the same.

### BACKGROUND ART

On a label, information concerning the related product, such as date and place of production, manufacturer, or the like, is marked for consumers to recognize them.

Labels are attached on various products. For example, the label may be affixed to a container or bottle containing detergents, chemicals, oils or beverages. Also, it may be used as a vehicle identification label. Further, it may be used in a variety of electronic products, semiconductors or medical instruments requiring prevention of forgery or alteration in order to ensure product reliability, allow quality management, improve product image, and so forth.

The labels can be produced in various ways. One of them is the laser marking technique.

Different marking mechanisms are available for laser marking of labels. One generally known example of laser marking uses a color pigment or interference pigment when irradiating laser (Japanese Patent Publication No. 2004-029726).

### DISCLOSURE

### Technical Problem

This disclosure is directed to providing a label capable of preventing decreased marking distinctness and quality change with time due to the presence of oxidation residues inside a base film of the label, when performing laser marking using a metal or metal oxide that experiences color change upon oxidization by laser, and, at the same time, having improved endurance including scratch resistance, chemical resistance and heat resistance, and a method for preparing the same.

### Technical Solution

In one general aspect, there are provided a label including: a first base film; a first ink layer formed on an outer side of the first base film and including a metal or metal oxide experiencing color change upon oxidization by laser; and a resin coating layer formed on the first ink layer to protect the first ink layer and transmitting laser wholly or partly to the first ink layer, and a method for preparing the same.

### Advantageous Effects

In accordance with the present disclosure, when performing laser marking using a metal or metal oxide that changes from its original color to another color by being oxidized by a laser, decreased marking distinctness or quality change with time due to the presence of oxidation residues inside a base film of the label may be prevented and endurance of the label including scratch resistance, chemical resistance and heat resistance may be improved. Accordingly, the label according to the present disclosure is widely applicable to various containers, vehicle identification labels, and products requiring prevention of forgery or alteration.

### DESCRIPTION OF DRAWINGS

FIGS. 1 to 13 schematically show the configuration of labels according to embodiments of the present disclosure.

### MODE FOR INVENTION

In the present disclosure, a side on which a release film is formed based on a first base film is defined as an “inner side” of the first base film, and the opposite side is defined as an “outer side” of the first base film.

In the present disclosure, a metal or metal oxide is used that changes from its original color to another color by being oxidized (i.e., change in oxidation number or change from incompletely oxidized state to completely oxidized state) by laser when laser is irradiated to a label. For example, if Ti₄O₇ is used as such pigment, its color changes from black to white (TiO₂) upon irradiation of laser.

Since the laser irradiation may induce such color change resulting form the change in oxidation state, a metal which experiences color change upon oxidization (e.g., Cu, Fe, Al, Ni, Mg, Ag or Sb as well as Ti) or a metal oxide [e.g., Fe₂O₂, Cu₂O, Ag₂O, Al₂O₂ or Mg₂O as well as TiₙO₂ₙ₋₁ (n is an integer from 1 to 10)] may be used for marking of a label using laser. In case of TiₙO₂ₙ₋₁, if n is an integer from 2 to 4, the metal oxide exhibits black color before laser irradiation. Especially, if n is 4, i.e., if Ti₄O₇ is used, the black color is more distinct.

The inventors have noted that, when the various metals or metal oxides are oxidized by laser irradiation and experience color change, oxidation residues may be formed as they are not completely oxidized to the desired oxides.

That is to say, when an ink layer is provided on an inner side of a first base film, fine oxidation residues may be formed upon laser irradiation, causing reduced marking efficiency and oxidation residues itself may cause quality change of the label with time due to the presence of oxidation residues in the laminate on the inner side of the first base film.

In accordance with the present disclosure, the location of the ink layer to be marked is controlled to prevent the decreased marking distinctness and quality change with time due to the presence of oxidation residues in the laminate structure on the inner side of the first base film.

That is to say, by forming the ink layer to be marked above the first base film (on the outer side of the first base film), not below the first base film (on the inner side of the first base film), formation of the oxidation residue may be reduced and, even when the oxidation residues are formed, decreased marking distinctness or quality change with time of the label may be prevented.

Also, in accordance with the present disclosure, to prevent, for example, scratching of the ink layer formed on the first base film, a resin coating layer is formed on the first ink layer to protect the first ink layer while the laser passing through a part or the whole of the resin coating layer is transmitted to the ink layer to allow marking of the ink layer. For reference, the resin coating layer may be partly removed upon laser irradiation by the laser energy. This means that part of the irradiated laser is used to remove the resin coating layer. In this case, the initially irradiated laser is transmitted not wholly but partly.

FIGS. 1 to 4 schematically show the configuration of labels according to embodiments of the present disclosure.

Referring to FIG. 1, a label 100 according to an embodiment of the present disclosure comprises a first ink layer 120, which comprises a metal (e.g., Ti, Cu, Fe, Al, Ni, Mg, Ag or Sb) or metal oxide experiencing color change upon oxidization by laser as a pigment, formed above (on an outer side of) a first base film 110. And, a resin coating layer 130 which protects the first ink layer 120 from external impact and transmits laser to the first ink layer 120 is formed on the first ink layer 120. Below (on an inner side of) the first base film 110, an agglutinant layer 140 and a release film 150 are formed in order.

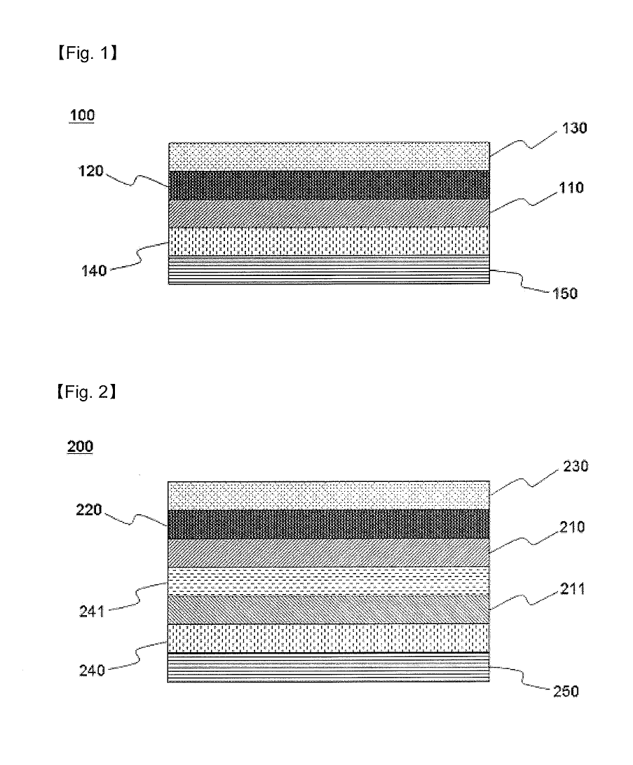

Referring to FIG. 2, a label 200 according to another embodiment of the present disclosure is similar to the label of FIG. 1 but is different in that an adhesive layer 241 and a second base film 211 are further provided below the first base film 210. The adhesive layer 241 serves to bond the first base film 210 with the second base film 211. As in FIG. 1, a first ink layer 220 and a resin coating layer 230 are formed in order above the first base film 210. Also, an agglutinant layer 240 and a release film 250 are formed in order below the second base film 211.

Referring to FIG. 3, a label 300 according to another embodiment of the present disclosure is similar to the label of FIG. 2 but is different in that a second ink layer 321 is further provided on a second base film 311. Above the second ink layer 321, an adhesive layer 341, a first base film 310, a first ink layer 320 and a resin coating layer 330 are formed in order. Also, an agglutinant layer 340 and a release film 350 are formed below the second base film 311.

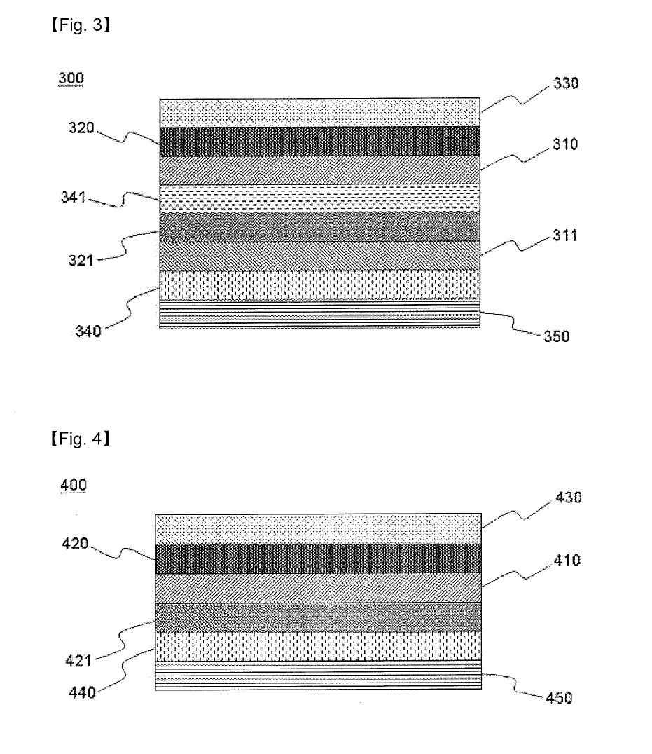

Referring to FIG. 4, a label 400 according to another embodiment of the present disclosure comprises a second ink layer 421 and a first ink layer 420 formed on a first base film 410. And, a resin coating layer 430 which protects the film from external impact and transmits laser to the first ink layer 420 is formed on the first ink layer 420. The second ink layer 421 is provided below the first ink layer 420. Below the first base film 410, a first agglutinant layer 440 and a release film 450 are formed in order.

Now, each layer of the label according to the embodiments of the present disclosure will be described in detail.

First, the first base film may be a heat-resistant film since heat is produced when laser is irradiated thereto. As specific examples, the first base film may be a polyolefin-, polyester (PET or PEN)- or polyimide-based film. Especially, the first base film may be a PET film. When a PET film is used, the film may have various colors as well as superior dimension stability and processability.

The thickness of the first base film is not particularly limited and may be adjusted adequately depending on the laser intensity. As a specific example, when a YAG laser (1,064 nm) is used, the first base film may have a thickness of 12 to 150 μm. If the thickness of the first base film is less than 12 μm, carbonization may occur during the laser irradiation due to instant heating. And, if the thickness exceeds 150 μm, workability of roll-to-roll printing may be not good.

If required, the first base film may be formed as a self-destructive film by half cutting, forming multiple small through-holes or forming a porous structure in order to prevent forgery or alteration. For example, the first base film may be half-cut previously by 10-50% of the film thickness, or a roll with diamond particles, needles or brushes attached thereon may be passed across the film to form through-holes of an irregular or regular linear pattern. In that case, forgery or alteration may be prevented since the film is broken when a label attached to the product is forcibly detached.

The first base film may have the same color as the marking color. In this case, the film may be given the desired color through the master batch method.

As described earlier, the first ink layer which is to be laser marked comprises a metal or metal oxide that changes from its original color to another color by being oxidized by a laser to reveal desired characters or pattern.

The laser is not specially limited. Specifically, a low-output YAG laser (1,064 nm) may be used. In general, when laser light is focused on a material, heat is produced as the absorbed light energy is converted to thermal energy.

This heat induces the oxidation of the metal or metal oxide and thus the color change of the ink layer. Accordingly, the desired color can be obtained by adequately selecting the metal or metal oxide and the laser irradiation intensity. Non-limiting examples of the metal oxidized upon laser irradiation may include Ti, Fe, Ag, Cu, Ni, Al or Sb. When an incompletely oxidized metal oxide, e.g., Ti₄O₇, is used, the output of laser irradiation may be decreased as compared to when the corresponding metal is used.

The first ink layer may be made of an acrylate urethane-based resin and comprise the metal or metal oxide. If necessary, the first ink layer may be configured a single layer or multiple layers. If the ink layer is configured as a single layer, production cost may be reduced and, stability of quality and convenience of processing may be attained.

The first ink layer may also be configured as multiple layers. In this case, a second-color ink layer may be formed of a metal or metal oxide with good laser absorption efficiency, such as Cu, Fe, Al, Ni or Ag. Since the second-color ink layer reinforces concealing effect, the laser marking efficiency may be enhanced even when a first-color ink layer is printed with minimum thickness.

The metal or metal oxide particles of the first ink layer may have a particle size greater than 0 μm and not greater than 1 μm. A well-controlled particle size ensures uniform quality during the laser marking. The smaller the particle size of the pigment particles, the denser they are in the ink layer and the better color change is attained upon oxidation.

The thickness of the first ink layer is not particularly limited. It may be greater than 0 μm and equal to or less than 5 μm. If the ink layer is thicker than 5 μm, workability may be not good and the resulting label may be too thick. More specifically, the first ink layer may be 0.5-2 μm thick.

The first ink layer may be printed by various printing techniques. For example, gravure printing, microgravure printing, reverse kiss coating, or the like may be employed. These printing techniques may reduce production cost because they allow mass production.

The resin coating layer is a coating layer formed on the first ink layer. While transmitting laser wholly or partly to the first ink layer, it protects the first ink layer from external impact or scratching.

The resin coating layer may be formed by coating a resin having excellent hardness on the first ink layer. That is to say, the resin coating layer may be a hard coating layer.

The resin coating layer may have a surface pencil hardness of at least 4H to ensure good scratch resistance.

The resin coating layer may be formed of a resin that is cured by application of energy, such as a UV-curable resin cured by light, a thermocurable resin cured by heat, or an EB-curable resin cured by electron beam. These resins may comprise an acryl-based polymer, a urethane-based polymer, an epoxy-based polymer, a silicone polymer, a silica polymer, or the like.

Particularly, the resin coating layer may comprise a photopolymerizable resin, a photoinitiator, a solvent, an additive, or the like. The photopolymerizable resin may be an oligomer, a monomer, a blend thereof, or a photopolymerizable prepolymer such as a cation-polymerizable prepolymer.

As non-limiting examples, the photoinitiator may be one or more selected from a group consisting of benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1 [4-(methylthio)phenyl]-2-morpholinopropan-1-one, 4-(2-hydroxyethoxy)phenyl 2-hydroxy-2-propyl ketone, benzophenone, p-phenylbenzophenone, 4,4′-d iethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2-4-diethylthioxanthone, benzyl dimethyl ketal, acetophenone dimethyl ketal and p-dimethylaminobenzoic acid ester.

If the photoinitiator is one for a cation-polymerizable prepolymer, it may be one or more compounds selected from a group consisting of, for example, onium including aromatic sulfonium, aromatic oxosulfonium or aromatic iodonium, tetrafluoroborate, hexafluorophosphate, hexafluoroantimonate and hexafluoroarsenate.

The photoinitiator may be used in an amount of 0.2 to 10 parts by weight based on 100 parts by weight of the photopolymerizable resin. If the photoinitiator content is below 0.2 part by weight, a desired addition effect of the photoinitiator may not be attained. And, a content exceeding 10 parts by weight may not be effective.

The solvent may be an aliphatic hydrocarbon such as hexane, heptane, cyclohexane, etc., an aromatic hydrocarbon such as toluene, xylene, etc., a halogenated hydrocarbon such as methylene chloride, ethylene chloride, etc., an alcohol such as methanol, ethanol, propanol, butanol, etc., a ketone such as acetone, methyl ethyl ketone, 2-pentanone, isophorone, etc., an ester such as ethyl acetate, butyl acetate, etc., or a cellosolve such as ethyl cellosolve, etc.

The additive may be an antioxidant, UV absorbent, photostabilizer, leveling agent, antifoaming agent, matting agent, or the like. Specifically, it may be silica, alumina, talc, clay, calcium carbonate, magnesium carbonate, barium sulfate, aluminum hydroxide, titanium dioxide, zirconium oxide, or the like.

The resin coating layer may be coated with a thickness of 4 to 12 μm in dry state. If the thickness is less than 4 μm, desired surface pencil hardness and UV curability may not be attained. And, if it exceeds 12 μm, burring may occur upon laser irradiation.

The agglutinant layer is formed on one side of the first base film or on one side of the second base film or the release film which will be described later.

The agglutinant layer should maintain its adhesion force upon laser irradiation and have printability, thermal stability, chemical resistance and oil resistance. When considering these factors, the agglutinant layer may comprise an acryl-, silicone- or urethane-based agglutinant agent.

As a specific example, the agglutinant may be one having low initial agglutinant force to allow easy removal when the film is falsely attached to an undesired spot and, after being heated to a certain temperature (80-90° C.), having increased adhesion force. In this case, workability is improved during attachment of the film and, after attachment, the film may be induced to tear or break when the film is forcibly detached.

For example, when the agglutinant layer comprises an acryl-based agglutinant with excellent heat resistance, a low-viscosity or high-viscosity adhesive may be used. Gravure coating may be employed when a low-viscosity acryl-based agglutinant is used. And, when a high-viscosity acryl-based agglutinant is used, S knife coating (also known as comma coating) may be employed. The agglutinant may be coated in an amount of 10 to 15 g/m² in wet state.

The second base film reinforces stiffness of the marking film, provides color contrast with the first base film or the first ink layer, and, depending on situations, may provide fragility to the film. The second base film is an additional base film provided supplement the first base film.

As specific examples, the second base film may be a polyolefin (OPP or PE)-, polyester (PET or PEN)- or polyimide (PI)-based film. More specifically, it may be a PET film. When considering workability, heat resistance and processability, the second base film may have a thickness of 12 to 100 μm.

The second base film may have the same color as the marking color in order to provide color contrast with the first ink layer. That is to say, by using a second base film having a color contrasted with that of the coating layer, the marked pattern or characters may be seen distinctly. For example, if it is configured such that the first ink layer is black and white characters are marked upon laser irradiation, the white characters may be seen more clearly when the second base film is white.

Further, the first base film and/or the second base film may be made self-destructive by half cutting, forming multiple small through-holes or forming a porous structure in order to prevent forgery or alteration.

In that case, forgery or alteration may be prevented since the film is broken when a label attached to the product is forcibly detached.

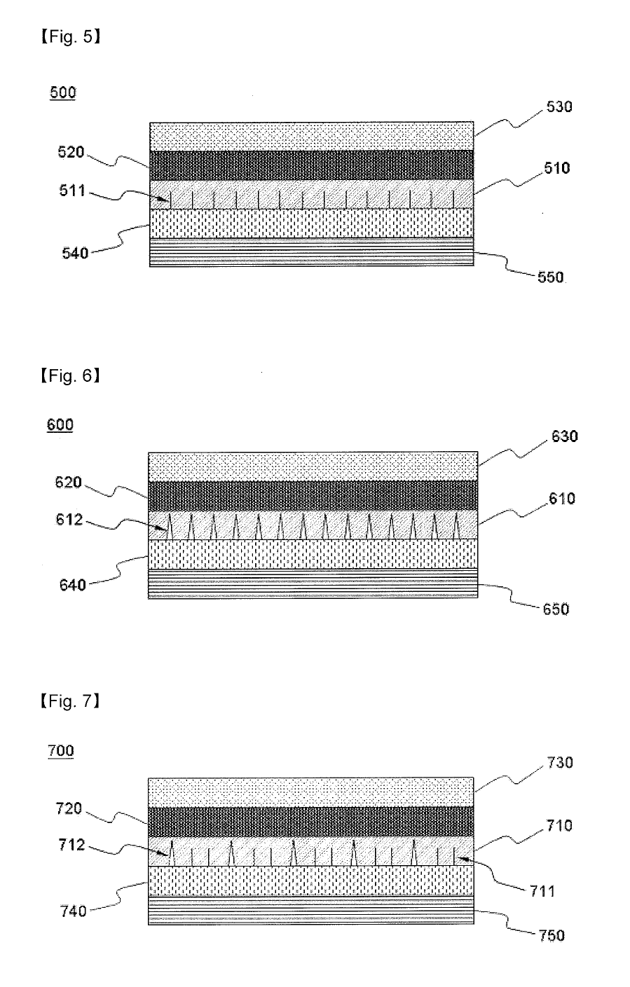

FIGS. 5 to 13 show the embodiments wherein the label is half-cut and/or has multiple small through-holes formed therein.

Referring to FIG. 5, a label 500 according to an embodiment of the present disclosure comprises a first ink layer 520 comprising a metal (e.g., Ti, Cu, Fe, Al, Ni, Mg, Ag or Sb) or a metal oxide experiencing color change as a pigment on a first base film 510. A resin coating layer 530 protecting the film from external impact and transmitting laser to the first ink layer 520 is formed on the first ink layer 520. Below the first base film 510, an agglutinant layer 540 and a release film 550 are provided in order. The first base film 510 has half-cuts 511. Accordingly, when a force is applied to the label 500, the label 500 is broken easily because of the half-cuts 511.

Referring to FIG. 6, a label 600 according to another embodiment of the present disclosure is identical to the label of FIG. 5 except that multiple small through-holes 612 are formed on a first base film 610. Above the first base film 610 on which the small through-holes 612 are formed, a resin coating layer 630 and a first ink layer 620 are provided. And, an agglutinant layer 640 and a release film 650 are provided below the first base film 610.

A label 700 illustrated in FIG. 7 comprises a resin coating layer 730 and a first ink layer 720 formed above a first base film 710. An agglutinant layer 740 and a release film 750 are formed below the first base film 710. The first base film 710 has half-cuts 711 as well as multiple small through-holes 712. In case the small through-holes 712 and the half-cuts 711 are formed together on the first base film 710, two half-cuts 711 may be formed between the through-holes 712 as shown in FIG. 7. Although the location and number of the half-cuts 711 and the through-holes 712 are not particularly limited, the label 700 may fracture easily when force is applied thereto in that case.

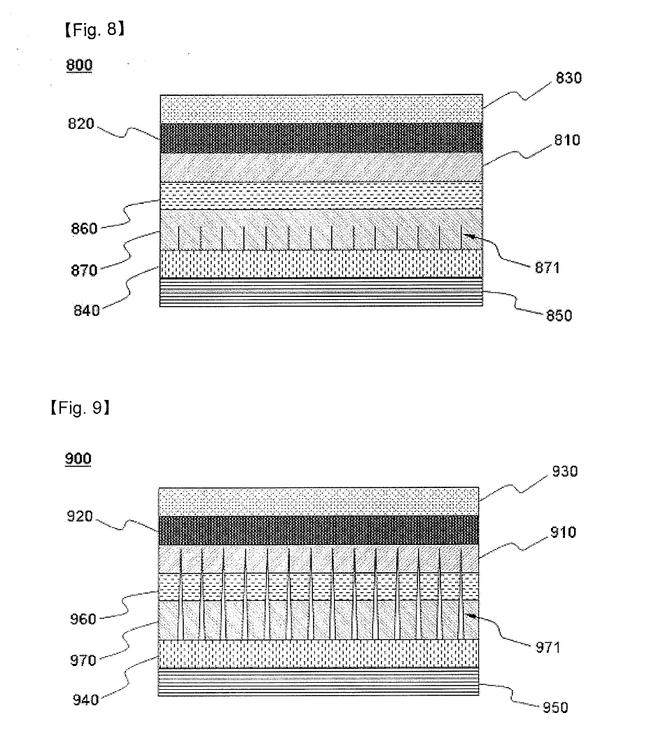

A label 800 illustrated in FIG. 8 comprises a resin coating layer 830 and a first ink layer 820 above a first base film 810. An agglutinant layer 840 and a release film 850 are formed in order below the first base film 810. Between the first base film 810 and the agglutinant layer 840, an adhesive layer 860 and a second base film 870 are provided. And, the second base film 870 has half-cuts 871.

A label 900 illustrated in FIG. 9 comprises a resin coating layer 930 and a first ink layer 920 above a first base film 910. An agglutinant layer 940 and a release film 950 are formed below the first base film 910. Between the first base film 910 and the first agglutinant layer 940, an adhesive layer 960 and a second base film 970 are provided. And, the second base film 970 has multiple small through-holes 971 formed thereon. The small through-holes 971 may penetrate the second base film 970 and the adhesive layer 960 and extend to the first base film 910.

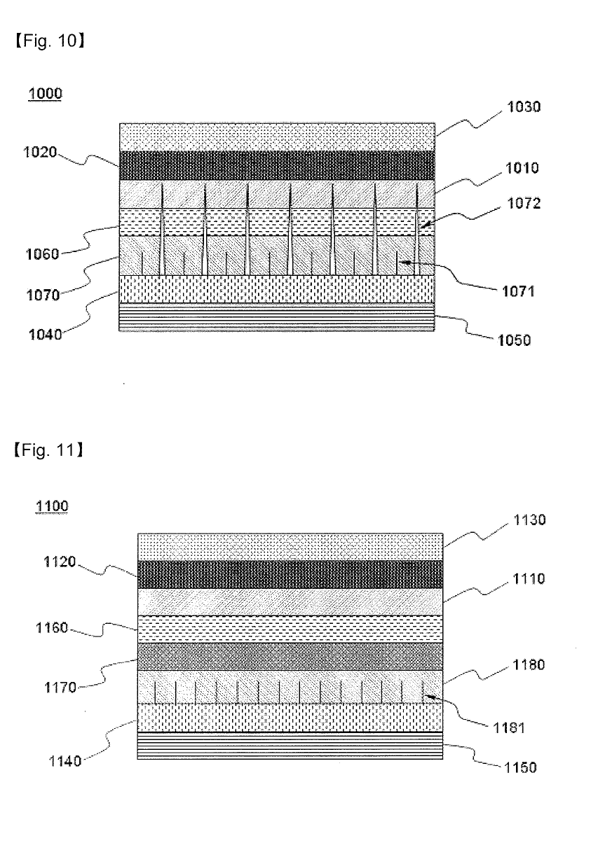

A label 1000 illustrated in FIG. 10 comprises a resin coating layer 1030 and a first ink layer 1020 formed above a first base film 1010. An agglutinant layer 1040 and a release film 1050 are formed below the first base film 1010. Between the first base film 1010 and the first agglutinant layer 1040, an adhesive layer 1060 and a second base film 1070 are provided. And, the second base film 1070 has half-cuts 1071 as well as multiple small through-holes 1072. The small through-holes 1072 may penetrate the second base film 1070 and the adhesive layer 1060 and extend to the first base film 1010. The location and number of the half-cuts 1071 and the multiple small through-holes 1072 are selected such that the label may fracture easily when force is applied thereto.

A label 1100 illustrated in FIG. 11 comprises a resin coating layer 1130 and a first ink layer 1120 formed above a first base film 1110. An agglutinant layer 1140 and a release film 1150 are formed below the first base film 1110. Between the first base film 1110 and the agglutinant layer 1140, an adhesive layer 1160, a second ink layer 1170 and a second base film 1180. The second base film 1180 has half-cuts 1181 formed thereon.

A label 1200 illustrated in FIG. 12 has the same configuration as the label 1100 illustrated in FIG. 11. Specifically, a resin coating layer 1230 and a first ink layer 1220 are formed above a first base film 1210. An agglutinant layer 1240 and a release film 1250 are formed in order below the first base film 1210. Between the first base film 1210 and the agglutinant layer 1240, an adhesive layer 1260, a second ink layer 1270 and a second base film 1280 are provided. The second base film 1280 has small through-holes 1281 formed thereon. The small through-holes 1281 may penetrate the second base film 1280, the second ink layer 1270 and the adhesive layer 1260 and extend to the first base film 1210.

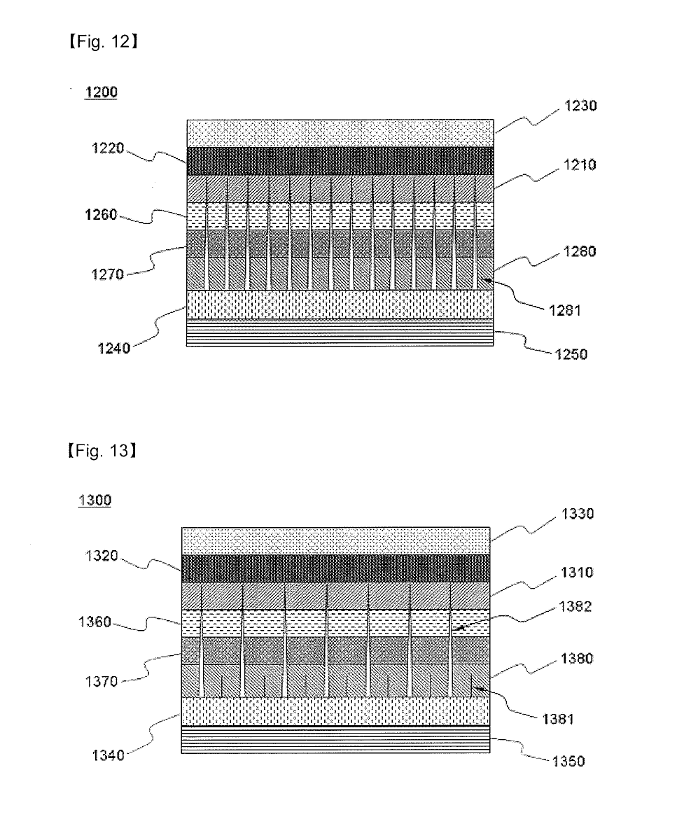

A label 1300 illustrated in FIG. 13 has both half-cuts 1381 and multiple through-holes 1382. Specifically, a resin coating layer 1330 and a first ink layer 1320 are formed above a first base film 1310, and an agglutinant layer 1340 and a release film 1350 are formed below the first base film 1310. Between the first base film 1310 and the agglutinant layer 1340, an adhesive layer 1360, a second ink layer 1370 and a second base film 1380 are provided. The second base film 1380 has both the half-cuts 1381 and the multiple small through-holes 1382 formed thereon. The small through-holes 1382 penetrate the second base film 1380, the second ink layer 1370 and the adhesive layer 1360 and extend to the first base film 1310. The location and number of the half-cuts 1381 and the multiple small through-holes 1382 are selected such that the label 1300 may fracture easily when force is applied thereto. The small through-holes 1382 are made longer since the label 1300 has a large thickness.

The release film is formed on the innermost side of the label. The release film is removed before the label is attached to the product, such that the agglutinant layer contacts directly with the product. The release film may be a silicone-coated PET film or a fluorine-coated fluorine film (in case a silicone-based adhesive is used). The release film may comprise a curing agent such as an epoxy-based silane crosslinking agent as well as an additive such as a Pt catalyst. Further, silicone may be added to the release film in order to provide releasability corresponding to the adhesion force of the agglutinant layer.

If required, the label may further comprise an additional ink layer (second ink layer) in addition to the first ink layer on the inner side of the first base film. Further, an adhesive layer for bonding the second base film with the first base film or bonding the first base film with the ink layer may be provided. The adhesive layer provides adhesion even after the laser irradiation and has printability, adhesion stability, chemical resistance and oil resistance.

As described above, the present disclosure thoroughly solves the problem of decreased marking efficiency resulting from the fine oxidation residues remaining in the film after the laser irradiation. By providing the ink layer on the first base film and forming the resin coating layer thereon to protect the ink layer, marking efficiency is improved and the risk of color change or film fracture during the preparation process is minimized because the laser needs not have strong intensity. In addition, by forming the resin coating layer for protecting the ink layer using a high-hardness resin or a curable resin, film strength and scratch resistance may be improved.

Further, high-quality printing is possible using an ink for single-layer laser printing. The single-layer printing reduces production cost. In addition, the label is free from various contaminants and may be used semi-permanently since it has superior chemical resistance, heat resistance, or the like. Besides, a self-destructive film may be provided by half-cutting the film or forming multiple small through-holes thereon in order to prevent forgery or alteration.

The examples and experiments will now be described. The following examples and experiments are for illustrative purposes only and not intended to limit the scope of this disclosure.

[Preparation of Labels of Example and Comparative Example]

The label described with reference to FIG. 1 was prepared as a label of Example. Specifically, the label was prepared by forming a first ink layer 120 comprising Ti₄O₇ as a pigment on an outer side of a first base film 110, forming a resin coating layer 130 comprising an acryl-based polymer on the first ink layer 120, and forming an agglutinant layer 140 and a release film 150 below the first base film 110. The configuration of the agglutinant layer, the release film and the first base film may be replaced by any one described in the foregoing embodiments.

For comparison, a label of Comparative Example was prepared by forming a first ink layer 120 comprising Ti₄O₇ as a pigment between a first base film 110 and an agglutinant layer 140, without a resin coating layer 130.

Thus prepared labels of Example and Comparative Example were subjected to marking by irradiating YAG laser.

[Determination of Whiteness]

After performing marking for the labels of Example and Comparative Example, a spectrophotometer was used to determine lightness (L*) and color difference (AE) of the marked white portion. For reference, an L* value of “+” represents white, and a value of “−” represents black. The color difference (ΔE) considers not only the lightness (L*) but also chromaticity (a*b*) as determined by hue and saturation, and is calculated automatically.

The label of Example exhibited an L* value of 94.04, whereas the label of Comparative Example exhibited an L* value of 90.56. This means that the label of Example was whiter, i.e., had better laser marking efficiency, than the label of Comparative Example.

The color difference (ΔE) of the Example label and the Comparative Example label was 4.53. For reference, if ΔE is 0 to 0.5, the difference is hardly distinguishable. If ΔE is 0.5 to 1.5, there is slight difference. And, if E is larger than 1.5, the difference is appreciable.

When the labels of Example and Comparative Example were allowed to stand in the air for a day, the label of Comparative Example showed color change at the marked portion.

It can be concluded that the difference in whiteness and color change results from the presence or absence of oxidation residues.

1. A label comprising:
a first base film;
a first ink layer formed on the exterior top part of the first base film, and comprising a metal or metal oxide that changes from its original color to another color by being oxidized by a laser; and
a resin coating layer coated on the first ink layer to protect the first ink layer, wherein the laser passing through a part or the whole of the resin coating layer is transmitted to the first ink layer.

2. The label according to claim 1, which comprises:
an agglutinant layer;
the first base film formed on the agglutinant layer;
the first ink layer formed on the first base film; and
the resin coating layer formed on the first ink layer.

3. The label according to claim 1, which comprises:
an agglutinant layer;
a second base film formed on the agglutinant layer;
an adhesive layer formed on the second base film;
the first base film formed on the adhesive layer;
the first ink layer formed on the first base film; and
the resin coating layer formed on the first ink layer.

4. The label according to claim 1, which comprises:
an agglutinant layer;
a second base film formed on the agglutinant layer;
a second ink layer formed on the second base film;
an adhesive layer formed on the second ink layer;
the first base film formed on the adhesive layer;
the first ink layer formed on the first base film; and
the resin coating layer formed on the first ink layer.

5. The label according to claim 1, which comprises:
an agglutinant layer;
a second ink layer formed on the agglutinant layer;
the first base film formed on the second ink layer;
the first ink layer formed on the first base film; and
the resin coating layer formed on the first ink layer.

6. The label according to claim 1, which further comprises a release film formed below the agglutinant layer.

7. The label according to claim 1, wherein the resin coating layer has a surface pencil hardness of at least 4H.

8. The label according to claim 1, wherein the resin coating layer is formed with a thickness of 4 to 12 μm in dry state.

9. The label according to claim 1, wherein the resin coating layer comprises a resin which is cured by application of UV, electron beam or heat.

10. The label according to claim 1, wherein the resin coating layer comprises one or more polymers selected from a group consisting of acryl polymer, urethane polymer, epoxy polymer, silicon polymer and silica polymer.

11. The label according to claim 1, wherein the resin coating layer comprises a photopolymerizable resin and a photoinitiator.

12. The label according to claim 11, wherein the photoinitiator is one or more compounds selected from a group consisting of benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholinopropan-1-one, 4-(2-hydroxyethoxy)phenyl 2-hydroxy-2-propyl ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2-4-diethylthioxanthone, benzyl dimethyl ketal, acetophenone dimethyl ketal and p-dimethylaminobenzoic acid ester.

13. The label according to claim 11, wherein the photoinitiator is one or more compounds selected from a group consisting of onium including aromatic sulfonium, aromatic oxosulfonium or aromatic iodonium, tetrafluoroborate, hexafluorophosphate, hexafluoroantimonate and hexafluoroarsenate.

14. The label according to claim 11, wherein the photoinitiator is used in an amount of 0.2 to 10 parts by weight based on 100 parts by weight of the photopolymerizable resin.

15. The label according to claim 1, wherein the first base film is half-cut, has through-holes formed thereon, or is half-cut and has through-holes formed thereon.

16. The label according to claim 1, wherein the first ink layer comprises a metal selected from a group consisting of Ti, Cu, Fe, Al, Ni, Mg, Ag and Sb or a metal oxide selected from a group consisting of TiₙO₂ₙ₋₁ (n is an integer from 1 to 10), Fe₂O₂, Cu₂O, Ag₂O, Al₂O₂ and Mg₂O.

17. The label according to claim 16, wherein the first ink layer comprises a single layer.

18. The label according to claim 1, wherein the first ink layer comprises an upper first-color ink layer and a lower second-color ink layer, and the second-color ink layer comprises a metal selected from a group consisting of Ti, Cu, Fe, Al, Ni, Mg, Ag or Sb or a metal oxide selected from a group consisting of TiₙO₂ₙ₋₁ (n is an integer from 1 to 10), Fe₂O₂, Cu₂O, Ag₂O, Al₂O₂ or Mg₂O.

19. The label according to claim 1, wherein the metal or metal oxide of the first ink layer has a particle size greater than 0 μm and equal to or less than 1 μm.

20. The label according to claim 3, wherein the second base film is a color contrast layer.

21. The label according to claim 3, wherein the second base film is half-cut, has through-holes formed thereon, or is half-cut and has through-holes formed thereon.

22. The label according to claim 3, wherein the second base film has a color the same as that of the first ink layer after laser irradiation.

23. The label according to claim 3, wherein the second base film is a color contrast layer.

24. The label according to claim 4, wherein the second base film is half-cut, has through-holes formed thereon, or is half-cut and has through-holes formed thereon.

25. The label according to claim 4, wherein the second base film has a color the same as that of the first ink layer after laser irradiation.

26. A method for preparing a label, comprising:
coating a first ink layer comprising a metal or metal oxide that changes from its original color to another color by being oxidized by laser on the exterior top part of a first base film; and
coating a resin protecting the first ink layer and passing laser through a part or the whole of the resin coating layer is transmitted to the first ink layer on the first ink layer.
